(19) United States
(12) Patent Application Publication
(10) Pub. No.: US 2014/0003043 A1
(43) Pub. Date: Jan. 2, 2014

(54) LUMINAIRE

(71) Applicant: Shigetoshi KOMIYAMA, Kanagawa-ken (JP)

(72) Inventor: Shigetoshi KOMIYAMA, Kanagawa-ken (JP)

(73) Assignee: Toshiba Lighting & Technology Corporation, Kanagawa-ken (JP)

(21) Appl. No.: 13/618,525

(22) Filed: Sep. 14, 2012

(30) Foreign Application Priority Data
Jun. 29, 2012 (JP) 2012-147021

(51) Int. Cl. F21L 4/00; F21L 4/02

(52) U.S. Cl. 362/184; 362/157

(57) ABSTRACT

A luminaire in an exemplary embodiment includes a tube-shaped housing extending in a first direction, a mounting plate provided in the interior of the housing, and having a light source mounting plate and a power supply mounting plate, a light source module provided on the light source mounting plate, a power supply unit provided on the power supply mounting plate, and a flexible and translucent cover. The cover includes a pair of flange portions engaging respectively with a pair of grooves formed on the housing, and closes an opening of the housing. Gaps are formed between the flange portions of the cover and a substrate of the light source module, and the flange portions become slidable between the grooves and the substrate through the gaps by bending the cover.

### CROSS-REFERENCE TO RELATED APPLICATION

This application is based upon and claims the benefit of priority from Japanese Patent Application No. 2012-147021, filed on Jun. 29, 2012; the entire contents of which are incorporated herein by reference.

### FIELD

Embodiments described herein relate generally to a luminaire that employs a light-emitting element such as an LED (Light Emitting Diode), for example, as a light source.

### BACKGROUND

For example, there is a line luminaire provided in the vicinity of a corner between indoor wall and ceiling to provide an indirect illumination effect by illuminating mainly the wall. A housing of such a line luminaire is formed into a long tube shape. Since an LED module, a mounting plate configured to hold the LED module, and a power supply unit are inserted from an end opening of the housing into the tube-shaped housing by being slid in the longitudinal direction of the housing, a large assembly space is required. In addition, in the case of the elongated housing, the workability in assembly may be lowered.

### DESCRIPTION OF THE DRAWINGS

FIG. 1 is an appearance perspective view of a luminaire according to an exemplary embodiment;

FIG. 2 is an end view illustrating an interior of the luminaire;

FIG. 3 is an end view in which a reinforcing plate is removed from FIG. 2;

FIG. 4 is a perspective view of an LED module in the luminaire;

FIG. 5 is an end view of a power supply unit in the luminaire;

FIG. 6 is a perspective view of a mounting plate in the luminaire;

FIG. 7 is a perspective view illustrating a positional relationship of the mounting plate and the reinforcing plate in the luminaire;

FIG. 8 is a perspective view in which the power supply unit is added to a configuration in FIG. 7;

FIG. 9 is a schematic drawing illustrating a method of assembling the luminaire; and

FIG. 10 is a schematic drawing illustrating a method of mounting a cover with respect to a housing in the luminaire.

### DETAILED DESCRIPTION

A luminaire in an exemplary embodiment includes a tube-shaped housing extending in a first direction, a mounting plate provided in the interior of the housing, a light source module, a power supply unit, and a flexible and translucent cover. The housing includes an opening formed continuously in the first direction, and a pair of grooves formed respectively in the vicinities of both edge portions in a second direction orthogonal to the first direction in the opening and extending in the first direction. The mounting plate includes a light source mounting plate facing the opening and a power supply mounting plate facing an inner wall of the housing. The light source module includes a substrate provided on the light source mounting plate and a light-emitting element mounted on the substrate with a light-emitting surface thereof oriented toward the opening. The power supply unit is provided on the power supply mounting plate. The cover includes a pair of flange portions engaging respectively with the pair of grooves, and closes the opening. The light-emitting surface of the light-emitting element is located on the side of the opening with respect to the flange portions. Gaps are formed between the flange portions and the substrate, and the flange portions become slidable between the grooves and the substrate through the gaps by bending the cover.

Referring now to the drawings, the exemplary embodiment will be described below. In the respective drawings, the same components are designated by the same reference numerals.

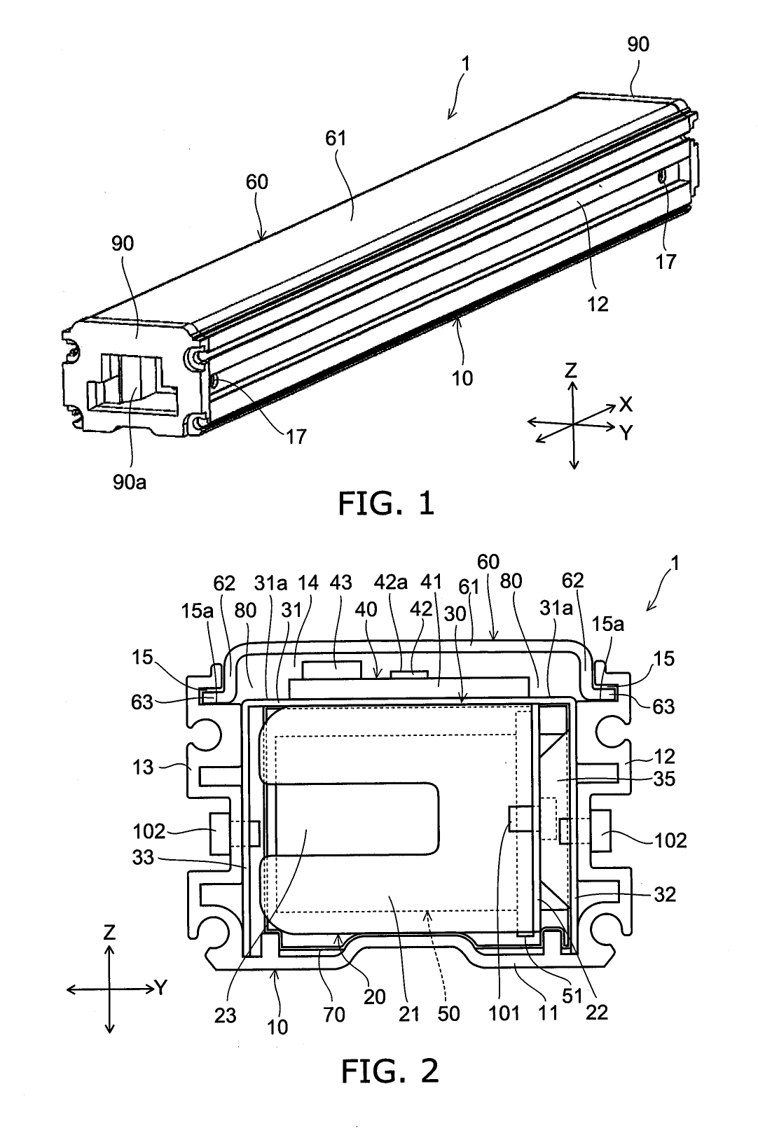

FIG. 1 is an appearance perspective view of a luminaire 1 according to an exemplary embodiment.

In the present specification, a longitudinal direction of the luminaire 1 is defined as a first direction X, a direction orthogonal to the first direction X which corresponds to the direction of the width of the luminaire 1 is defined as a second direction Y, and a direction orthogonal to the first direction X and the second direction Y is defined as a third direction Z.

An appearance of the luminaire 1 includes a housing 10, a cover 60, and end caps 90. The housing 10 and the cover 60 extend in the first direction X, and the end caps 90 are provided respectively at both end portions of the housing 10 and the cover 60 in the first direction X.

FIG. 2 is an end view viewing the interior of the luminaire 1 in a state in which one of the end caps 90 is removed.

Accommodated within a space surrounded by the housing 10 and the cover 60 are a light source module 40, a power supply unit 50, and reinforcing plates 20. The light source module 40, the power supply unit 50, and the reinforcing plates 20 are fixed to a mounting plate 30 provided in the housing 10.

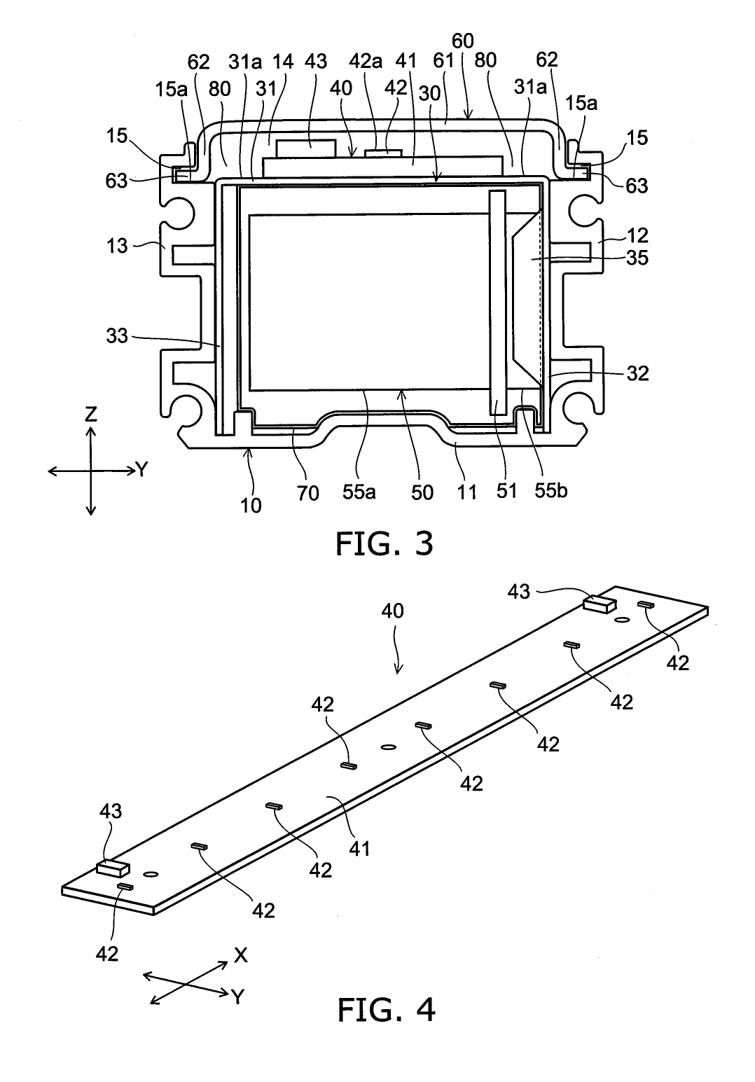

FIG. 3 is an end view in which the reinforcing plates 20 are removed from FIG. 2.

The housing 10 will be described first.

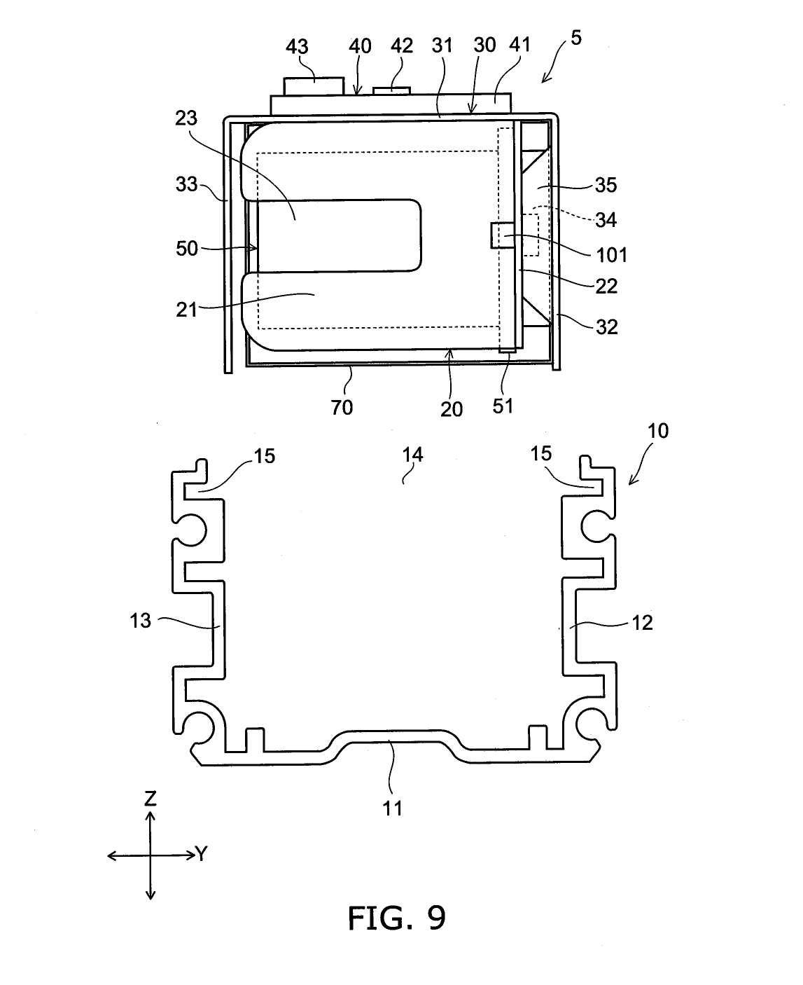

FIG. 9 illustrates the housing 10 only on a lower side thereof.

The housing 10 is formed into a tube-shape including a bottom wall portion 11 and a pair of side wall portions 12 and provided integrally, and opened at both ends in the longitudinal direction (the first direction X). The pair of side wall portions 12 and 13 are provided perpendicularly with respect to the bottom wall portion 11 and face each other in parallel. The housing 10 is an extrude part formed of a metallic material such as aluminum.

Formed in the interior of the housing 10 is a space surrounded by the bottom wall portion 11 and the pair of side wall portions 12 and 13, and an opening 14 is formed at a position facing the bottom wall portion 11 by the intermediary of the space therebetween. In top view in FIG. 2 and FIG. 3, the opening 14 is formed into a rectangular shape, and extends continuously in the first direction X (in the direction penetrating the paper planes of FIGS. 2 and 3).

Formed in the vicinities of both edge portions of the opening 14 in the second direction Y are a pair of grooves 15. The grooves 15 are formed on inner walls of the side wall portions 12 and 13 so as to continue from the edge portions of the opening 14 to the interior of the housing 10, and extend in the first direction X.

As illustrated in FIGS. 2 and 3, the grooves 15 are located on the outside in the second direction Y with respect to the mounting plate 30 and the light source module 40 accommodated in the housing 10.

The mounting plate 30 will now be described.

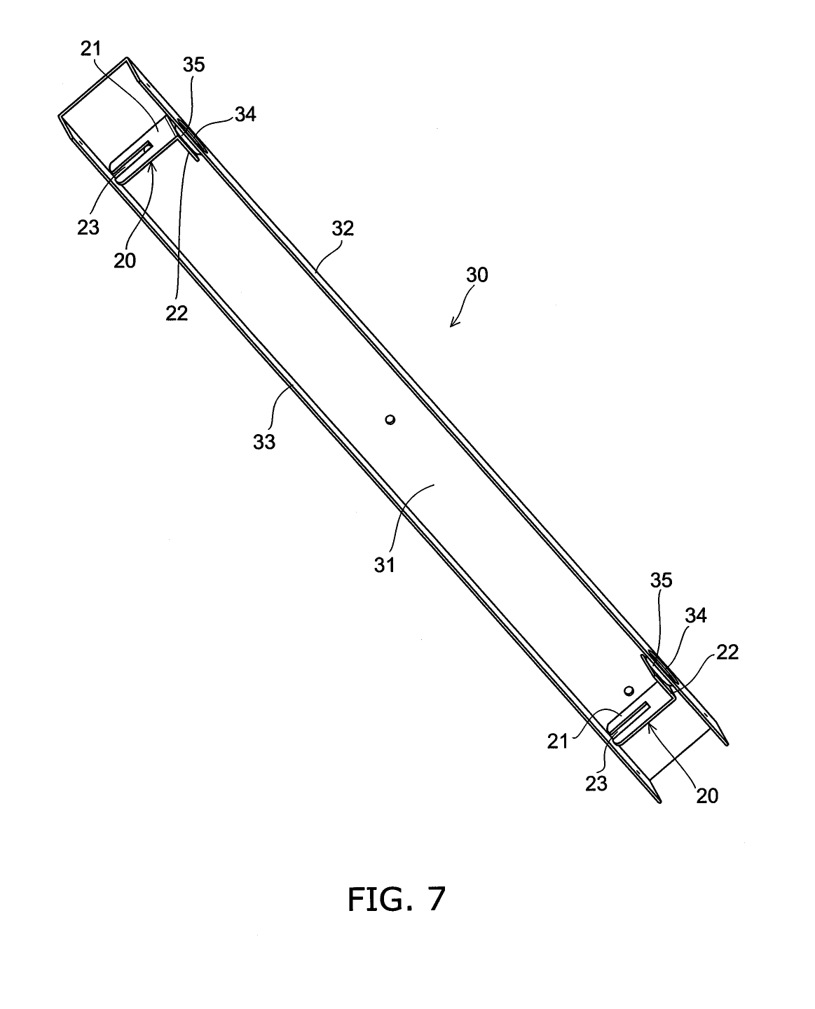

FIGS. 6 and 7 illustrate perspective views of the mounting plate 30.

FIG. 7 illustrates also the reinforcing plates 20.

The mounting plate 30 includes three metallic plates (for example, iron plates) provided integrally. All of the three metallic plates extend in the first direction X. The three metallic plates include a light source mounting plate 31 and a pair of side plates 32 and 33 provided perpendicularly to the light source mounting plate 31. A portion of the mounting plate 30 facing the light source mounting plate 31 is not provided with the metallic plate, but is opened.

As illustrated in FIGS. 2 and 3, the light source mounting plate 31 faces the opening 14 in the housing 10. The pair of side plates 32 and 33 respectively extend from edge portions of the light source mounting plate 31 in the second direction Y to the opposite side of the opening 14 (the side of bottom wall portion 11 of the housing 10).

The pair of side plates 32 and 33 face the inner walls of the side wall portions 12 and 13 of the housing 10 in the housing 10, respectively. One of the pair of side plates 32 and 33 functions as a power supply mounting plate 32.

As illustrated in FIG. 7, a pair of boss portions 35 projecting inward (the side of the other side plate 33) are provided on an inner wall of the power supply mounting plate 32. The pair of boss portions 35 are respectively provided at positions closer to the end portions of the power supply mounting plate 32 in the longitudinal direction (the first direction X). As illustrated in FIGS. 2 and 3, the boss portions 35 project toward a power supply substrate 51 of the power supply unit 50, described later, in the housing 10.

Provided on an outer wall of the power supply mounting plate 32 on the back side of the boss portions 35 are depressions 34 as illustrated in FIG. 6.

As illustrated in FIG. 7, a pair of the metallic reinforcing plates 20 are provided on the inner side of the mounting plate 30. The reinforcing plates 20 each include a first plate portion 21 and a second plate portion 22 provided perpendicularly and integrally with respect to the first plate portion 21.

The second plate portions 22 are secured to the boss portions 35 of the power supply mounting plate 32 with screws as described later. In this state, the first plate portions 21 come into contact with the inner wall of the light source mounting plate 31 so as to partition the inner space of the mounting plate 30 in the first direction X in a position parallel to a YZ plane as illustrated in FIG. 2.

Therefore, the reinforcing plates 20 come into contact with the power supply mounting plate 32 and the light source mounting plate 31 on the inner side of the mounting plate 30 to enhance the strength of the mounting plate 30.

Subsequently, the light source module 40 will be described.

FIG. 4 is a perspective view of the light source module 40.

The light source module 40 includes a substrate 41 and light-emitting elements 42. A wiring pattern, not illustrated, is formed on the substrate 41, and the light-emitting elements are mounted on the substrate 41 and are electrically connected to the wiring pattern. The substrate 41 extends in the first direction X and the plurality of light-emitting elements 42 are arranged in the longitudinal direction of the substrate 41 (the first direction X).

A connector 43 is also mounted on the substrate 41, and the connector 43 is electrically connected to the light-emitting elements 42 via the wiring pattern formed on the substrate 41.

The light-emitting elements 42 are, for example, Light Emitting Diodes (LEDs). If semiconductors formed of gallium nitride (GaN) based compound, for example, is used as a material of an active layer of the LED, a short-wavelength light having a wavelength of 500 nm or shorter is obtained. However, the material of the active layer is not limited to the semiconductors formed of gallium nitride based compound.

In addition to the LEDs, Organic Light-Emitting Diodes (OLEDs), Inorganic Electro Luminescence light-emitting elements, Organic Electro Luminescence light-emitting elements, or other Electro Luminescence light-emitting elements, for example, may be used as the light-emitting elements 42.

The light-emitting elements 42 also include a fluorescent layer. In the exemplary embodiment, for example, the light-emitting elements 42 emit light of white or light bulb color as mixed colors of blue light and yellow light by a combination of an LED emitting blue light and a phosphor layer containing phosphor which absorbs the blue light (excitation light) and converts the absorbed light into yellow light.

As illustrated in FIGS. 2 and 3, the light source module 40 is provided on the light source mounting plate 31 of the mounting plate 30. For example, the substrate 41 is secured to the light source mounting plate 31 with screws. The light-emitting elements 42 is mounted on the substrate 41 with a light-emitting surface thereof facing the opening 14 formed on the housing 10.

Subsequently, the power supply unit 50 will be described.

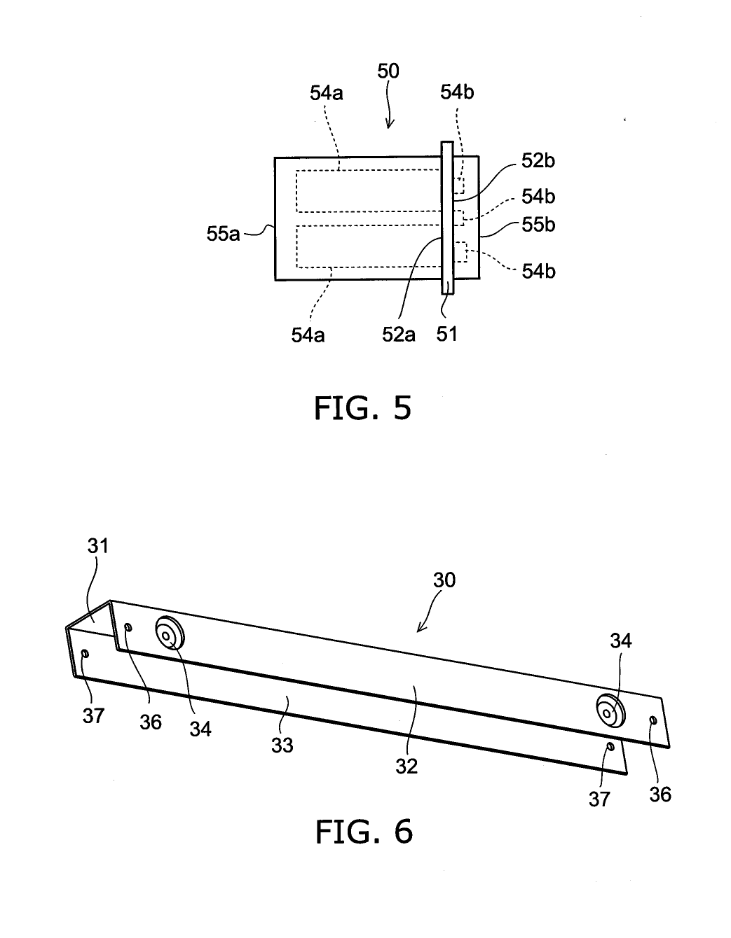

FIG. 5 is an end view of the power supply unit 50.

The power supply unit 50 includes the power supply substrate 51 extending in the first direction X (the direction penetrating the paper plane of FIG. 5), circuit components 54a and 54b mounted on the power supply substrate 51, and power supply cases 55a and 55b.

The circuit components 54a and 54b are mounted on both surfaces of the power supply substrate 51. Relatively tall components 54a are mounted on a first surface 52a of the power supply substrate 51, and relatively low components 54b are mounted on a second surface 52b opposite the first surface 52a. The power supply case 55a covers the components 54a on the first surface 52a side of the power supply substrate 51, and the power supply case 55b covers the components 54b on the second surface 52b side.

The power supply unit 50 is mounted on the power supply mounting plate 32 with the second surface 52b on which the low components 54b are mounted facing toward the inner wall of the power supply mounting plate 32 illustrated in FIGS. 2 and 3. The power supply unit 50 is provided in a space surrounded by the light source mounting plate 31 and the pair of side plates 32 and 33.

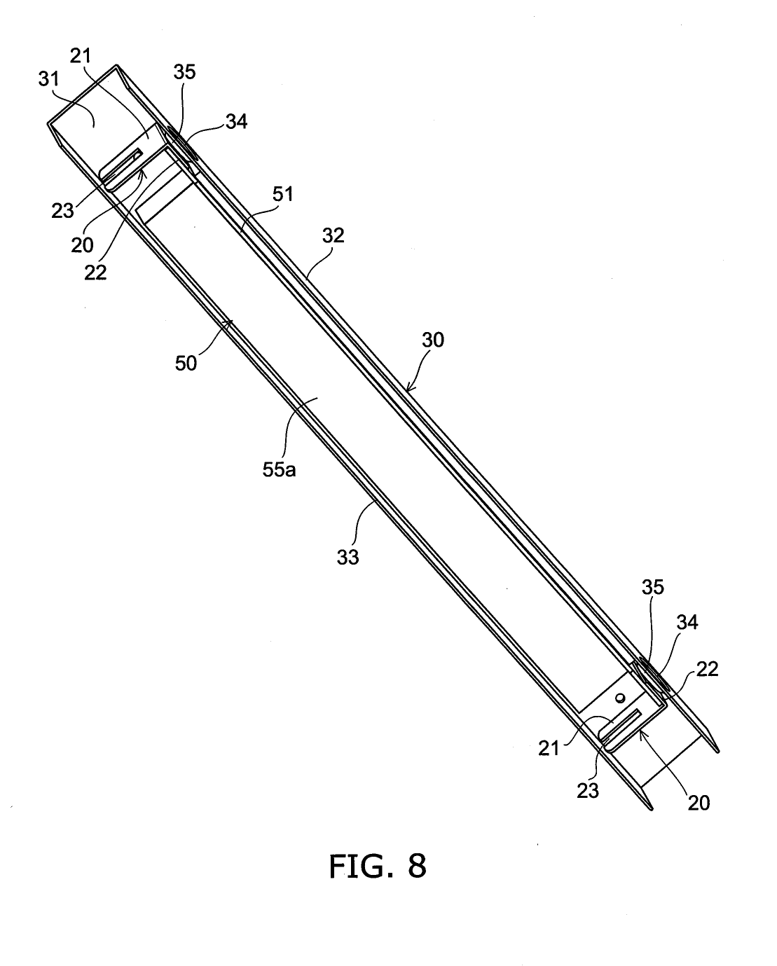

As illustrated in FIGS. 7 and 2, the second plate portions 22 of the reinforcing plates 20 are placed on the boss portions 35 projecting from the inner wall of the power supply mounting plate 32 one on top of another in contact therewith. As illustrated in FIGS. 8 and 2, both end portions of the power supply substrate 51 in the longitudinal direction (the first direction X) are placed on the insides of the second plate portions 22 one on top of another in contact therewith.

Therefore, the both end portions of the power supply substrate 51 are supported on the pair of boss portions 35 and the power supply substrate 51 is apart from the inner wall of the power supply mounting plate 32. The low components 54b mounted on the second surface 52b is accommodated within a space between the power supply mounting plate 32 and the power supply substrate 51.

As illustrated in FIG. 3, an insulating sheet 70 formed of a resin is provided between an inner wall of the mounting plate 30 and the power supply unit 50. The insulating sheet surrounds the periphery of the power supply unit 50 continuously on the inner side of the mounting plate 30. The insulating sheet 70 is also interposed between the bottom wall portion 11 of the housing 10 and the power supply unit 50.

In other words, the insulating sheet 70 is interposed between the components 54a and 54b of the power supply unit 50 and the metallic members (the housing 10 and the mounting plate 30) therearound, and high insulating properties are secured between the components 54a and 54b and the metallic members (the housing 10 and the mounting plate 30).

Subsequently, the cover 60 will be described.

The cover 60 is formed of a resin material having permeability (translucency) and diffuseness with respect to the light radiated from the light-emitting element 42. The cover 60 has flexibility.

The cover 60 includes a main surface portion 61, a pair of side surface portions 62 provided respectively at both end portions of the main surface portion 61 in the second direction Y, and a pair of flange portions 63 provided so as to project from the respective side surface portions 62 to the outside in the second direction Y. The main surface portion 61, the side surface portions 62 and the flange portions 63 are provided integrally and extend in the first direction X. The length of the cover 60 in the first direction X is the same as the length of the housing 10 in the first direction X.

As illustrated in FIGS. 2 and 3, the main surface portion 61 faces light-emitting surfaces 42a of the light-emitting elements 42 with a space therebetween. The side surface portions 62 protrude into the opening 14 formed on the housing 10 and face an edge portion of the opening 14. The pair of side surface portions 62 respectively face both side surfaces of the substrate 41 in the second direction Y with a space therebetween. The opening 14 is closed by the main surface portion 61 and the side surface portions 62.

The cover 60 isolates the light source module 40 and the power supply unit 50 accommodated in the interior of the housing 10 from the space outside the housing 10 and protects the light source module 40 and the power supply unit 50. Furthermore, the cover 60 also functions as a light distribution control member by providing the cover 60 with diffuseness.

The pair of flange portions 63 of the cover 60 enter the pair of grooves 15 formed on the housing 10 respectively and engage therewith. By the engagement of the flange portions 63 with inner walls of the grooves 15 on the opening 14 side (the upper side in FIGS. 2 and 3), the cover 60 is prevented from coming apart from the opening 14, so that a closed state of the opening 14 by the cover 60 is stably maintained.

In a state in which the cover 60 is mounted on the housing 10, the light-emitting surfaces 42a of the light-emitting elements 42 are located on the opening 14 side with respect to the grooves 15 and the flange portions 63. Therefore, light extracting efficiency from the light-emitting elements 42 to the outside of the housing 10 may be enhanced by inhibiting vignetting of light at an inner wall of the housing 10 or the flange portions 63 of the cover 60.

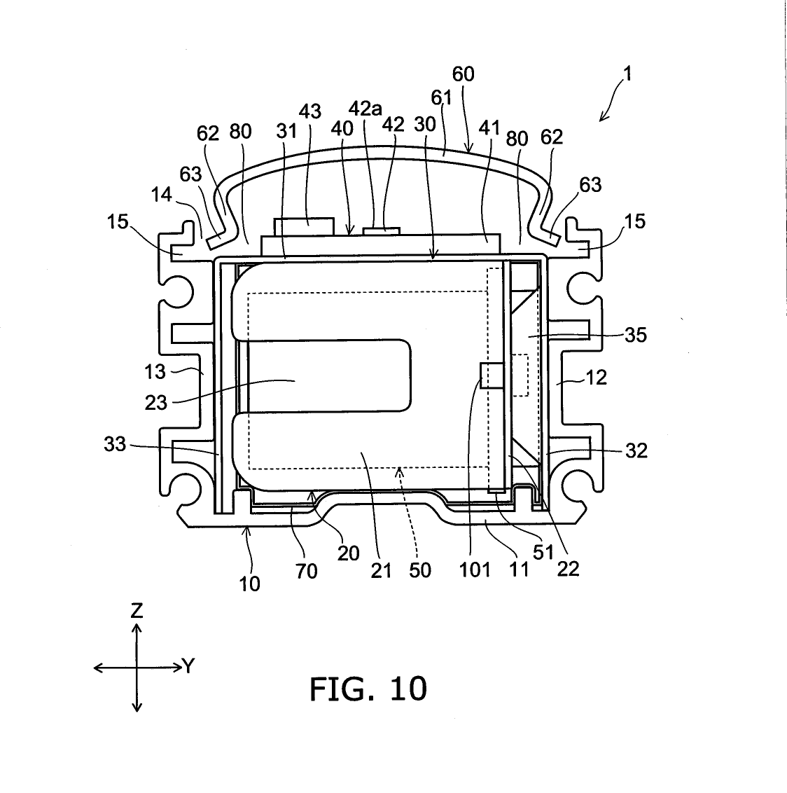

Subsequently, referring to FIGS. 9 and 10, a method of assembling the luminaire 1 according to the exemplary embodiment will be described.

According to the exemplary embodiment, as illustrated in FIG. 9, after assembly of the light source module 40, the power supply unit 50, and the reinforcing plates 20 to the mounting plate 30 on the outside of the housing 10, an assembly 5 is inserted from the opening 14 into the interior of the housing 10.

The light source module 40 is assembled on an outer surface of the light source mounting plate 31. For example, the substrate 41 is secured to the light source mounting plate 31 with screws.

As illustrated in FIG. 8, the second plate portions 22 of the reinforcing plates 20 and the power supply substrate 51 of the power supply unit 50 are placed on the boss portions 35 of the power supply mounting plate 32 one on top of another. Then, screws 101 illustrated in FIG. 9 are inserted through the boss portions 35, the second plate portions 22 of the reinforcing plates 20 and the power supply substrate 51 from the outer wall side of the power supply mounting plate 32 on the back side of the boss portions 35.

Therefore, the power supply substrate 51 and the reinforcing plates 20 are fixed to the power supply mounting plate 32 with the common screws 101, so that cost reduction on the basis of the reduction of the number of components and the number of assembly processes is achieved.

The width of the substrate 41 of the light source module 40 in the second direction Y is smaller than the width of the light source mounting plate 31 in the second direction Y, and the substrate 41 does not project from the light source mounting plate 31 in the second direction Y.

The power supply unit 50 and the reinforcing plates 20 are accommodated within the mounting plate 30. Head portions of the screws 101 are accommodated within the depressions 34 illustrated in FIG. 6 formed on the back sides of the boss portions 35, and do not project outward from the outer wall of the power supply mounting plate 32. Therefore, one side plate (the power supply mounting plate) 32 and the other side plate 33 of the mounting plate 30 form an outer shape of the assembly 5 in the second direction Y.

The width of the mounting plate 30 in the second direction Y is smaller than the width of the opening 14 of the housing 10 in the second direction Y. Therefore, the mounting plate 30 on which the light source module 40, the power supply unit 50, and the reinforcing plates 20 are mounted may be inserted through the opening 14 into the housing 10 from above the housing 10 in FIG. 9.

The operation of insertion described above requires a smaller working space than the operation of insertion by sliding the assembly 5 into the housing 10 from an opening at the end of the housing 10 in the longitudinal direction, so that the assembly operation is easy.

The assembly 5 obtained by assembling the light source module 40, the power supply unit 50, and the reinforcing plates 20 on the mounting plate 30 is accommodated in the housing 10, and then the cover 60 is mounted on the opening 14 to close the opening 14.

The cover 60 has flexibility, and in the natural state thereof, the outer dimension in the second direction Y including the flange portions 63 is larger than the width of the opening 14 in the second direction Y as illustrated in FIGS. 2 and 3.

Therefore, when mounting the cover 60 on the opening 14, as illustrated in FIG. 10, the cover 60 is bent so that the main surface portion 61 is deformed into a convex shape on the outside of the opening 14 and the pair of flange portions 63 are inserted into the inside of the opening 14. Then, as illustrated in FIGS. 2 and 3, the flange portions 63 are widened outward in the second direction Y and the flange portions 63 are engaged with the grooves 15.

Gaps 80 having the width in the second direction Y larger than the width of the flange portions 63 in the second direction Y are formed between the flange portions 63 engaged with the grooves 15 and the substrate 41 of the light source module 40. Therefore, the flange portions 63 may be slid between the grooves 15 and the substrate 41 through the gaps 80 by bending the cover 60 without being interfered with the substrate 41.

The flange portions 63 may be taken out to the gaps 80 from the grooves 15 by bending the cover 60 in the state in which the cover 60 is mounted on the opening 14, so that the cover 60 may be disassembled. In other words, the cover 60 may be detachably mounted on the opening 14, and the mounting and demounting operations are easily achieved only by bending the flexible cover 60.

Surfaces 31a of the light source mounting plate 31 facing the opening 14 and the gaps 80 on the outsides of the substrate 41 in the second direction Y are located alongside the grooves 15. Almost no level difference exists between the surfaces 31a and surfaces 15a (lower surfaces in FIGS. 2 and 3) of the grooves 15 farther from the opening 14.

Therefore, the flange portions 63 may be guided easily into the grooves 15 by bringing the flange portions 63 into contact with the surfaces 31a through the gaps 80 and sliding the flange portions 63 as-is sideways (toward the grooves 15). In other words, the surfaces 31a function as guide surfaces which cause the flange portions 63 to slide into the grooves 15.

The surfaces 31a also serve as the guide surfaces of the sliding operation of the flange portions 63 also when disassembling the cover 60 by sliding the flange portions 63 from the grooves 15 to the gaps 80.

The mounting plate 30 is fixed to the housing 10 by screws 102 illustrated in FIG. 2 within the housing.

As illustrated in FIG. 1, screw holes 17 are formed in the vicinity of both end portions of the side wall portion 12 of the housing 10 in the longitudinal direction (the first direction X). Although not illustrated, screw holes are formed at positions corresponding to the screw holes 17 of the side wall portion 12 on the side wall portion 13.

As illustrated in FIG. 6, screw holes 36 are formed in the vicinity of both end portions of the one side plate (power supply mounting plate) 32 of the mounting plate 30 in the longitudinal direction (the first direction X). Screw holes 37 are formed in the vicinity of both end portions of the other side plate 33 in the longitudinal direction. The screw holes 36 and 37 are formed on the end sides with respect to the depressions 34 and the boss portions 35.

The power supply mounting plate 32 is placed on the inner wall of the side wall portion 12 of the housing 10 on one top of another with the screw holes 36 formed on the power supply mounting plate 32 aligned with the screw holes 17 formed on the side wall portion 12 of the housing 10 as illustrated in FIG. 2. The side plate 33 is placed on the inner wall of the side wall portion 13 of the housing 10 on one top of another with the screw holes 37 formed on the other side plate 33 of the mounting plate 30 aligned with the screw holes formed on the other side wall portion 13 of the housing 10.

Then, the screws 102 are inserted into the screw holes from the outside of the housing 10, and the mounting plate 30 is fixed to the housing 10. As described above, the light source module 40, the power supply unit 50, and the reinforcing plates 20 are fixed to the mounting plate 30. Therefore, the light source module 40, the power supply unit 50, and the reinforcing plates 20 are fixed to the housing 10 via the mounting plate 30.

Attached to the both end portions of the housing 10 and the cover 60 in the longitudinal direction (the first direction X) are the end caps 90 as illustrated in FIG. 1.

An electric cable (not illustrated) connected to the power supply unit 50 is connected to the connector 43 of the light source module 40, and the light-emitting elements 42 is electrically connected to the power supply unit 50 via the connector 43 and the electric cable.

The power supply unit 50 accommodated in the interior of the housing 10 is electrically connected to a power supply provided on the outside of the housing 10 via the electric cable, not illustrated. The electric cable connects the power supply unit 50 and the external power supply through openings 90a formed on the end caps 90 and notch 23 formed on the first plate portions 21 of the reinforcing plates 20.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a tube-shaped housing extending in a first direction, the housing including an opening formed continuously in the first direction and a pair of grooves formed respectively in the vicinity of both edge portions of the opening in a second direction orthogonal to the first direction and extending in the first direction;
a mounting plate including a light source mounting plate facing the opening and a power supply mounting plate facing an inner wall of the housing, and provided in the interior of the housing;
a light source module including a substrate provided on the light source mounting plate and a light-emitting element mounted on the substrate with a light-emitting surface thereof oriented toward the opening;
a power supply unit provided on the power supply mounting plate; and
a flexible and translucent cover including a pair of flange portions engaging respectively with the pair of grooves and configured to close the opening,
the light-emitting surface of the light-emitting element being located on the opening side with respect to the flange portion, and
gaps being formed between the flange portions and the substrate, and the flange portions being slidable between the grooves and the substrate through the gaps by bending the cover.

2. The luminaire according to claim 1, wherein the width of the gaps in the second direction is larger than the width of the flange portions in the second direction.

3. The luminaire according to claim 1, wherein the width of the opening in the second direction is larger than the width of the mounting plate in the second direction.

4. The luminaire according to claim 1, further comprising an insulating sheet provided between the mounting plate and the power supply unit.

5. The luminaire according to claim 4, wherein the insulating sheet surrounds the periphery of the power supply unit continuously.

6. The luminaire according to claim 1, wherein the mounting plate includes three metallic plates extending in the first direction,
the three metallic plates include the light source mounting plate facing the opening, and a pair of side plates extending from the light source mounting plate to the opposite side of the opening, and
the power supply unit is provided on one of the pair of the side plates.

7. The luminaire according to claim 6, wherein the power supply unit is located in a space surrounded by the three metallic plates.

8. The luminaire according to claim 6, further comprising a reinforcing plate provided inside the mounting plate in contact with at least two of the three metallic plates.

9. The luminaire according to claim 8, wherein the power supply unit and the reinforcing plate are fixed to the power supply mounting plate with a common screw.

10. The luminaire according to claim 9, wherein an outer wall of the power supply mounting plate is provided with a depression, and
a head portion of the screw is located within the depression and does not project to the outside of the outer wall of the power supply mounting plate.

11. The luminaire according to claim 1, wherein the power supply unit includes a power supply substrate extending in the first direction, and a circuit component mounted on the power supply substrate.

12. The luminaire according to claim 11, wherein the power supply mounting plate is formed with a plurality of boss portions on an inner wall thereof so as to project toward the power supply substrate,
the power supply substrate is supported by the boss portions, and the power supply substrate is apart from the inner wall of the power supply mounting plate, and
the circuit component is mounted on each of both surfaces of the power supply substrate.

13. The luminaire according to claim 1, wherein surfaces of the light source mounting plate facing the opening on the outsides of the substrate are located alongside the grooves.

14. The luminaire according to claim 1, wherein the cover has diffuseness with respect to light emitted from the light-emitting element.

15. The luminaire according to claim 1, wherein a plurality of the light-emitting elements are mounted on the substrate in a line in the first direction.

16. A luminaire comprising:
a U-shaped housing extending in a longitudinal direction and having an opening extending in the longitudinal direction;
a light source mounting plate extending in the longitudinal direction and disposed within the housing;
a power supply mounting plate extending in the longitudinal direction and disposed within the housing;
a light source module including a substrate mounted on the light source mounting plate and a plurality of light-emitting elements arranged on the substrate to emit light through the opening;
a power supply unit mounted on the power supply mounting plate; and
a translucent cover extending in the longitudinal direction and positioned relative to the housing to close the opening and to cover the light source module.

17. The luminaire according to claim 16, further comprising:
a metallic plate extending in the longitudinal direction and disposed within the housing, wherein the metallic plate, the light source mounting plate, and the power supply mounting plate form a U-shape that is inverted relative to the U-shape of the housing.

18. The luminaire according to claim 17, wherein the power supply unit is located in a space surrounded by the metallic plate, the light source mounting plate, and the power supply mounting plate.

19. The luminaire according to claim 18, further comprising a reinforcing plate provided in the space surrounded by the metallic plate, the light source mounting plate, and the power supply mounting plate, and the power supply unit and the reinforcing plate are fixed to the power supply mounting plate with a common screw.

20. The luminaire according to claim 19, wherein an outer wall of the power supply mounting plate is provided with a recess, and a head portion of the common screw is located within the depression and does not project to the outside of the outer wall of the power supply mounting plate.
